(19) United States
(12) Patent Application Publication
(10) Pub. No.: US 2011/0113583 A1
(43) Pub. Date: May 19, 2011

(54) APPARATUS AND PROCESS FOR CONNECTING A WIPER BLADE TO A WIPER ARM

(76) Inventors: Subramaniam Shanmugham, Sugar Land, TX (US); Panduranga Rao Chirala Venkata, Hyderabad (IN); Rajam Raju Vegesna, Hyderabad (IN)

(21) Appl. No.: 12/999,517

(22) PCT Filed: Jun. 15, 2009
(86) PCT No.: PCT/US09/47324

§ 371 Date: Jan. 31, 2011

Related U.S. Application Data
(60) Provisional application No. 61/073,267, filed on Jun. 17, 2008.

(51) Int. Cl. B60S 1/34; B23P 19/04

(52) U.S. Cl. 15/250.32; 29/428

(57) ABSTRACT

An apparatus for connecting a wiper blade to a wiper arm (202), comprising a wiper blade adapter (2) and a locking tab (102) wherein the locking tab is releasably engageable with the wiper blade adapter such that when the locking tab releasably engages the wiper blade adapter at least a portion of the wiper arm is retained between the wiper blade adapter and the locking tab. A process for connecting a wiper blade to a wiper arm, comprising releasably engaging a locking tab with a wiper blade adapter such that when the locking tab releasably engages the wiper blade adapter at least a portion of the wiper arm is retained between the wiper blade adapter and the locking tab.

### FIELD OF THE INVENTION

The present invention relates to an apparatus and a process for connecting a wiper blade to a wiper arm.

### BACKGROUND OF THE INVENTION

Wiper blades comprise numerous shapes and sizes. Example wiper blades include flat blades, arm blades, and wiffle-tree blades. In addition to the numerous types of wiper blades, there are also numerous shapes and sizes of wiper arms. Example wiper arms include pin, hook, bayonet, and insert-and-lock (I&L). There are also numerous wiper blade adapters including small J-hook adapters and large J-hook adapters. There have also been numerous attempts to design apparatuses and processes for connecting more than one type of wiper blade to a wiper arm.

U.S. Pat. No. 6,640,380 discloses a connector for connecting a wiper blade assembly to a wiper arm. The connector includes first and second side walls spaced from one another to define a channel therebetween as well as a central bridge and rail interconnecting the first and second side walls. The central bridge and side walls define a pin passage and a rivet passage, each extending transverse to the channel. The rail is vertically spaced from the central bridge to define a tail space between the bridge and the rail. The forwardmost end of the rail is positioned rearward of the pin and rivet passages.

There is a continuing need for an apparatus and a process for connecting more than one type of wiper blade to a wiper arm. In particular, there is a need for an apparatus and a process for connecting more than one type of wiper blade to an insert-and-lock (I&L) wiper arm.

### SUMMARY OF THE INVENTION

An apparatus for connecting a wiper blade to a wiper arm, comprising a wiper blade adapter and a locking tab wherein the locking tab is releasably engageable with the wiper blade adapter such that when the locking tab releasably engages the wiper blade adapter at least a portion of the wiper arm is retained between the wiper blade adapter and the locking tab.

A process for connecting a wiper blade to a wiper arm, comprising releasably engaging a locking tab with a wiper blade adapter such that when the locking tab releasably engages the wiper blade adapter at least a portion of the wiper arm is retained between the wiper blade adapter and the locking tab.

### BRIEF DESCRIPTION OF THE DRAWINGS

For a detailed understanding of embodiments of the present invention, reference is made to the following description of example embodiments, taken in conjunction with the accompanying drawings, in which like elements have been given like numbers, wherein:

FIG. 1 is an isometric view of one embodiment of a wiper blade adapter in accordance with the present invention;

FIG. 2 is a cross-sectional view of the wiper blade adapter taken along lines 2-2 of FIG. 1;

FIG. 3 is an enlarged view of one end of the wiper blade adapter of FIG. 1;

FIG. 4 is an isometric view of the underside of the wiper blade adapter of FIG. 1;

FIG. 5 is an enlarged view of one end of the wiper blade adapter of FIG. 4;

FIG. 6 is an isometric view of an example embodiment of a locking tab in accordance with the present invention;

FIG. 7 is a side view of the locking tab of FIG. 6;

FIG. 8 is an exploded view of an example assembly comprising a wiper blade connector, an example embodiment of a wiper blade adapter in accordance with the present invention, and a wiper arm;

FIG. 9 is an isometric view of the example assembly of FIG. 8 after releasable engagement;

FIG. 10 shows the locking tab of FIG. 6 positioned to engage the example assembly of FIG. 9;

FIG. 11 shows the locking tab of FIG. 6 releasably engaging the wiper blade adapter in a first position;

FIG. 12 shows the locking tab of FIG. 6 releasably engaging the wiper blade adapter in a second position;

FIG. 13 shows the locking tab of FIG. 6 releasably engaging the wiper blade adapter, wiper blade connector, and wiper arm in a third position;

FIG. 14 shows the locking tab of FIG. 6 releasably engaging the wiper blade adapter, wiper blade connector, and wiper arm in a fourth position;

FIG. 15 shows the locking tab of FIG. 6 releasably engaging the wiper blade adapter, wiper blade connector, and wiper arm in a fifth position; and

FIG. 16 shows another example embodiment of a locking tab in accordance with the present invention positioned to engage with an example assembly comprising a wiper blade connector, another example embodiment of a wiper blade adapter in accordance with the present invention, and a wiper arm.

### DETAILED DESCRIPTION OF THE INVENTION

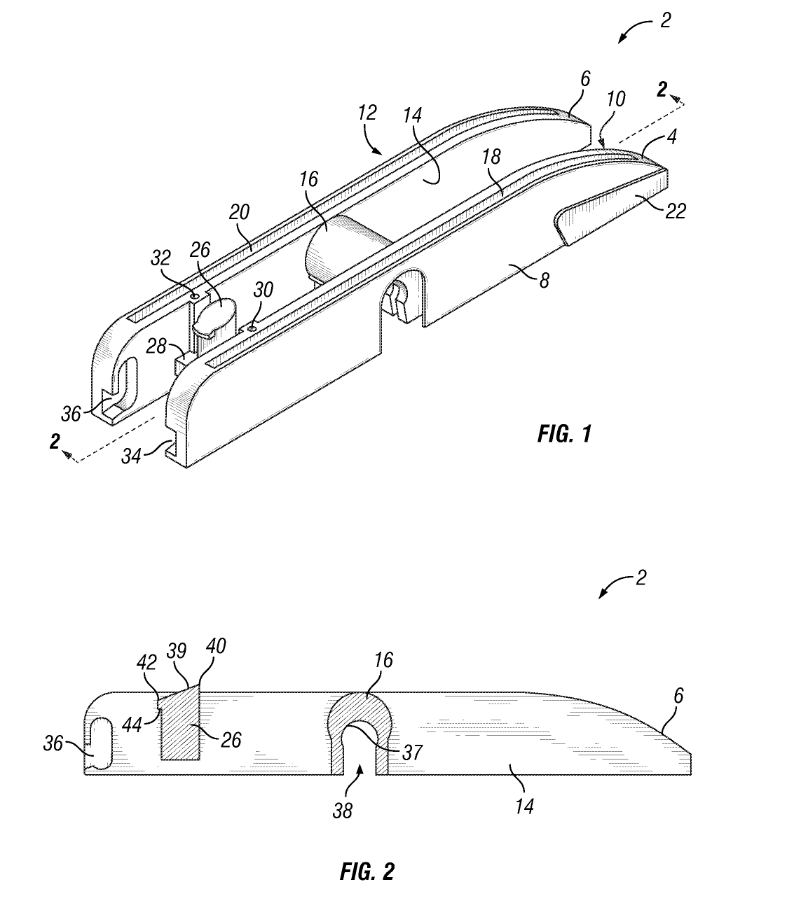

Referring to FIG. 1, one embodiment of a wiper blade adapter 2 comprises a first wall 4, a second wall 6, and a connector 16 extending therebetween. Walls 4 and 6 are substantially parallel and have substantially the same length. First wall 4 has an outer surface 8 and an inner surface 10. Second wall 6 has an outer surface 12 and an inner surface 14. Connector 16 connects first wall 4 and second wall 6 approximately halfway between the ends of walls 4 and 6. Walls 4, 6 include a first groove 18 and a second groove 20, respectively. While grooves 18, 20 are shown herein as passing completely through walls 4, 6, respectively, it should be understood that grooves 18, 20 may have any depth so long as grooves 18, 20 in the underside of wiper blade adapter 2 are deep enough, as measured from the underside of wiper blade adapter 2, to provide for releasable engagement of grooves 18, 20 with walls 204, 206, respectively, of wiper blade connector 200 as discussed in detail below. The upper edges of walls 4,6 include first and second lock pin holes 30, 32, respectively, which are inward of grooves 18, 20, respectively, and proximal to a lock post 26. Adapter 2 also comprises a first raised edge-foot 22 at one end of outer surface 8 and a second raised edge-foot 24 (not shown) at one end of outer surface 12. Lock post 26 is supported on a lock post support 28 which extends between inner surfaces 10, 14. Inner surface 10 includes a first guiding slot 34 at the end opposite from raised edge-foot 22. Similarly, inner surface 14 includes a second guiding slot 36 at the end opposite from raised edge-foot 24.

Referring to FIG. 2, connector 16 is shown in cross-section. FIG. 2 also shows inner surface 14 of second wall 6, lock post 26, and second guiding slot 36. Connector 16 may be in the form of an arch-shaped housing 37 defining a passageway 38 extending through walls 4 and 6. Lock post 26 comprises an upper surface 39 that slants at an angle from an upper edge 40 to a lower edge 42. The lower edge 42 of lock post 26 may include a lip 44 near lower edge 42 to help mate with locking tab 102 as discussed in detail below.

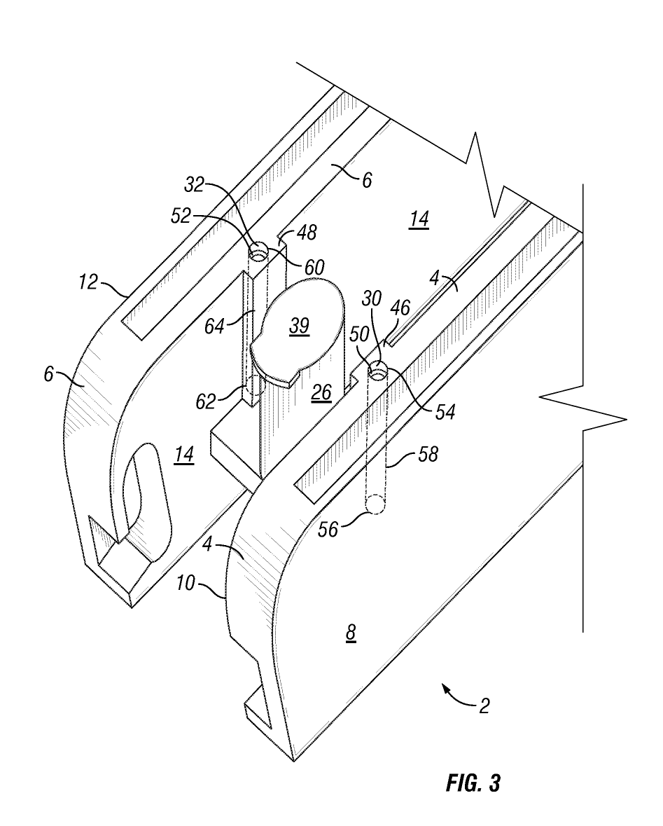

Referring to FIG. 3, wiper blade adapter 2 includes first and second wall extensions 46, 48 extending from inner surfaces 10, 14, respectively, to provide support for lock pin holes 30, 32, respectively. A first groove 50 slightly below the opening of first lock pin hole 30 extends around the inside circumference of first lock pin hole 30 for receiving a first ring of a first prong of locking tab 102 as described below. Similarly, a second groove 52 slightly below the opening of second lock pin hole 32 extends around the inside circumference of second lock pin hole 32 for receiving a second ring of a second prong of locking tab 102 as described below. First lock pin hole 30 includes a first open end 54, a first closed end 56, and a first passageway 58 therebetween. Second lock pin hole 32 includes a second open end 60, a second closed end 62, and a second passageway 64 therebetween. The grooves and rings of wiper blade adapter 2 and locking tab 102 provide for a groove-ring snap connection as described below.

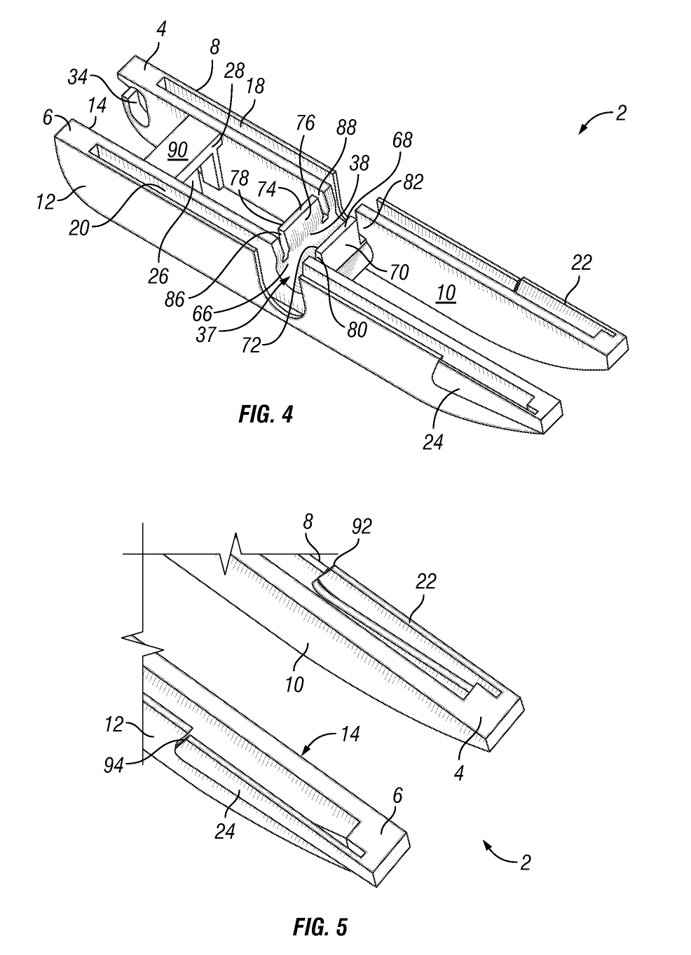

Referring to FIG. 4, the underside of wiper blade adapter 2 includes inside surface 66 of connector 16 (see also FIGS. 1 and 2) which defines arch-shaped housing 37 for passageway 38. Arch-shaped housing 37 is formed by a first side wall 68, which has an outer surface 70 and an inner surface 72, and a second side wall 74, which has an outer surface 78 and an inner surface 76. Side wall 68 includes notches 80, 82 between the ends of side wall 68 and the inner surfaces of the adjacent walls 6, 4, respectively. Side wall 74 includes notches 86, 88 between the ends of side wall 74 and the inner surfaces of the adjacent walls 6, 4, respectively. As discussed above, grooves 18, 20 pass completely through walls 4, 6, respectively, and are visible on the underside of wiper blade adapter 2. FIG. 4 also shows base 90 of lock post support 28 extending between inner surfaces 10 and 14. FIG. 4 also shows first raised edge-foot 22 of outer surface 8 of wall 4 and second raised edge-foot 24 of outer surface 12 of wall 6.

Referring to FIG. 5, the underside of wiper blade adapter 2, including raised edge-feet 22, 24, is shown in greater detail. Raised edge-feet 22, 24 provide lips 92, 94, respectively, to help secure wiper arm 202 as described below.

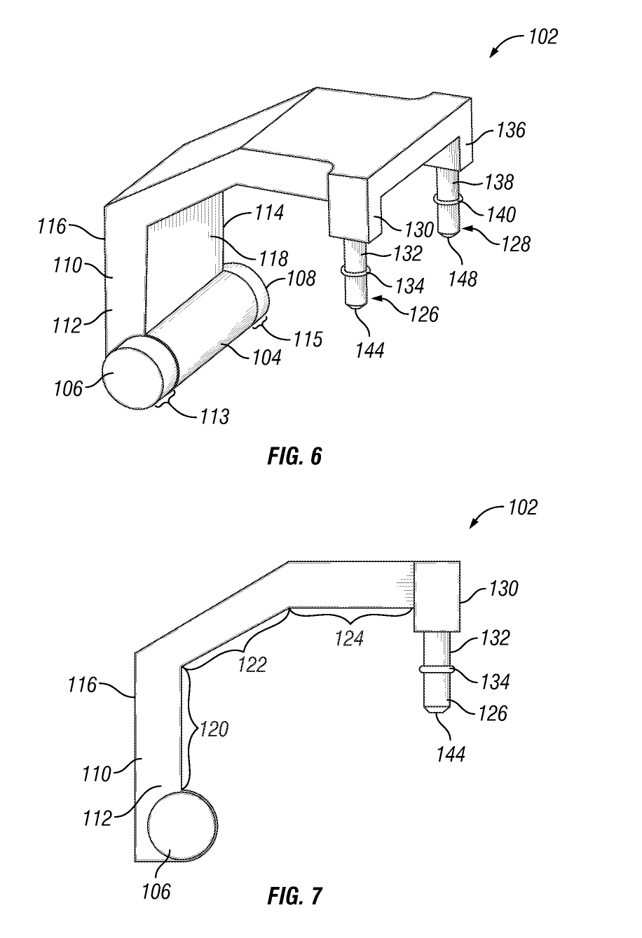

Referring to FIGS. 6 and 7, one embodiment of a locking tab 102 comprises a base 104 having a first end 106 and a second end 108. Locking tab 102 further comprises a first wall 110 extending up from base 104. A first edge 112 of first wall 110 is positioned at a distance 113 from first end 106. A second edge 114 of first wall 110 is positioned at a distance 115 from second end 108. Distance 113 is nearly equal to the depth of first guiding slot 34 of inner surface 10 (see FIG. 1). Distance 115 is nearly equal to the depth of second guiding slot 36 of inner surface 14 (see FIG. 1). First wall 110 includes an outer surface 116 and an inner surface 118. In some embodiments, first wall 110 includes three sections 120, 122, and 124 (see FIG. 7). First section 120 may be generally vertical to base 104, second section 122 may be generally at a forty-five degree (45°) angle to first section 120, and third section 124 may be generally at a forty-five degree (45°) angle to second section 122. In other embodiments (not shown), the angle of section 122 may vary. It is preferred, but not necessary, that third section 124 be perpendicular to first section 120.

Locking tab 102 further comprises, near the end of third section 124, a generally T-shaped section comprising a first prong 126 extending near the end of section 124 generally proximate to first edge 112 and a second prong 128 extending near the end of section 124 generally proximate to second edge 114. First prong 126 may be attached to a first square base 130 that may be a part of first wall 110. First prong 126 comprises a cylindrical extension 132 extending from first square base 130 and a first ring 134 to be inserted into first groove 50 (see FIG. 3) when in use. Second prong 128 may be attached to a second square base 136 that may be a part of first wall 110. Second prong 128 comprises a cylindrical extension 138 extending from second square base 136 and a second ring 140 to be inserted into second groove 52 (see FIG. 3) when in use. Prongs 126, 128 have distal ends 144, 148, respectively. When locking tab 102 is fully engaged with adapter 2, ends 144, 148 may seat against lower closed ends 56, 62, respectively, of pin holes 30, 32, respectively (see FIG. 3). Prongs 126, 128 fit into passageways 58, 64, respectively (see FIG. 3). When fully engaged, square bases 130, 136 are flush with wall extensions 46, 48, respectively (see FIG. 3).

It should be understood that a locking tab in accordance with the present invention may comprise any suitable shape and size that may be used in accordance with the present invention. It should also be understood that the numerous sections of a locking tab in accordance with the present invention may comprise separate sections that may be connected by any suitable means known in the art, for example, adhesion, welding, and combinations thereof. In other embodiments, a locking tab in accordance with the present invention may comprise one piece that may be prepared using any suitable means known in the art, for example, blow molding and injection molding.

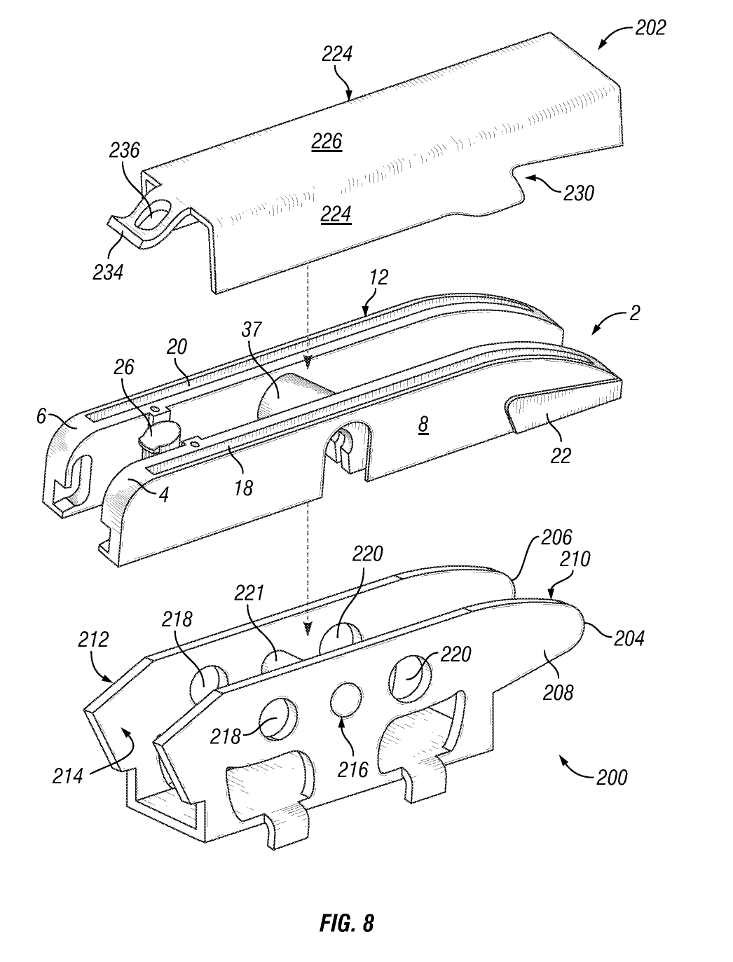

FIG. 8 shows an example of a commercial wiper blade connector 200 that, for example, may be pre-installed on a wiper blade or included with a wiper blade in a package for later installment. Examples of a suitable wiper blade connector include any wiper blade connector that may be used in accordance with the present invention. Examples of a suitable wiper blade include any wiper blade that may be used in accordance with the present invention and include, for example, flat blades, arm blades, wiffle-tree blades, and combinations thereof. Examples of a suitable wiper arm include any wiper arm that may be used in accordance with the present invention and include, for example, insert-and-lock wiper arms, also referred to as I & L arms.

FIG. 8 shows wiper blade connector 200 comprising a first wall 204 and a second wall 206. Walls 204 and 206 are substantially parallel and have substantially the same length. First wall 204 includes an outer surface 208 and an inner surface 210. Second wall 206 includes an outer surface 212 and an inner surface 214. Walls 204, 206 also include one or more apertures, for example, apertures 216, 218, and 220, substantially parallel from wall 204 to wall 206, for connecting one or more attachments (not shown) for connecting the wiper blade to various wiper arms. In the example embodiment shown in FIG. 8, wiper blade connector 200 includes a center-radiused rivet 221 that engages center aperture 216 of walls 204, 206.

Still referring to FIG. 8, a wiper arm 202, for example, a commercial insert-and-lock (I&L) wiper arm, comprises a channel-shaped body comprising a top wall 226 and side walls 224. Each side wall 224 includes a notch 230 whose shape substantially conforms to the shape of the raised-edge feet 22, 24 of wiper blade adapter 2. Second wall 226 comprises a lock post receiver 234 having a lock post passageway 236 therethrough for receiving lock post 26 as discussed in detail below. In one embodiment, when in use, wiper blade adapter 2 and wiper blade connector 200 may be releasably engaged. When in use, grooves 18, 20 in the underside of wiper blade adapter 2 releasably engage walls 204, 206, respectively, of wiper blade connector 200. Also, arch-shaped housing 37 of wiper blade adapter 2 may releasably engage center-radiused rivet 221 on wiper blade connector 200.

When in use, side walls 224 of wiper arm 202 pass outside of and adjacent to outer surfaces 8, 12 of walls 4, 6, respectively. The portions of top wall 226 adjacent to side walls 224 are positioned on walls 4, 6, respectively. When in use, lock post 26 passes through lock post passageway 236 of lock post receiver 234. Notches 230 in side walls 224 releasably engage raised edge-feet 22, 24.

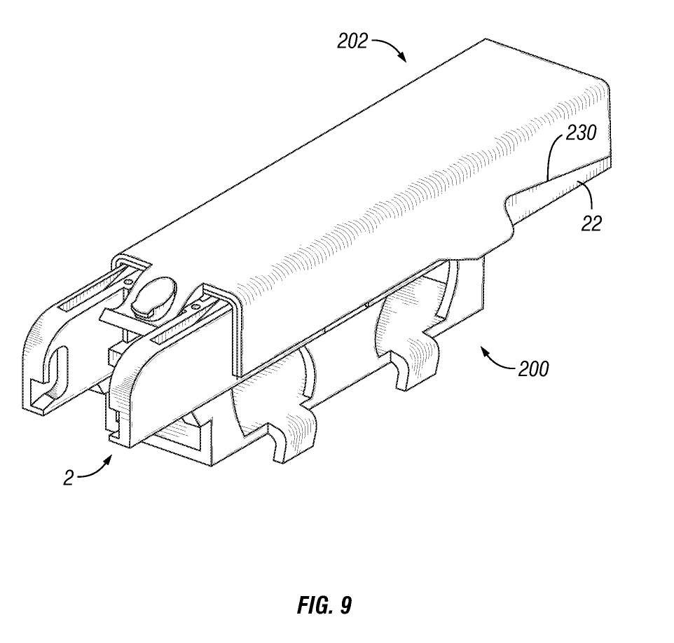

FIG. 9 shows an example assembly of wiper blade connector 200, wiper blade adapter 2, and wiper arm 202 of FIG. 8 after releasable engagement. FIG. 9 also shows one of the notches 230 releasably engaged with raised edge-foot 22 of outer surface 8. Similarly, while not shown, the other notch 230 is releasably engaged with raised edge-foot 24 of outer surface 12.

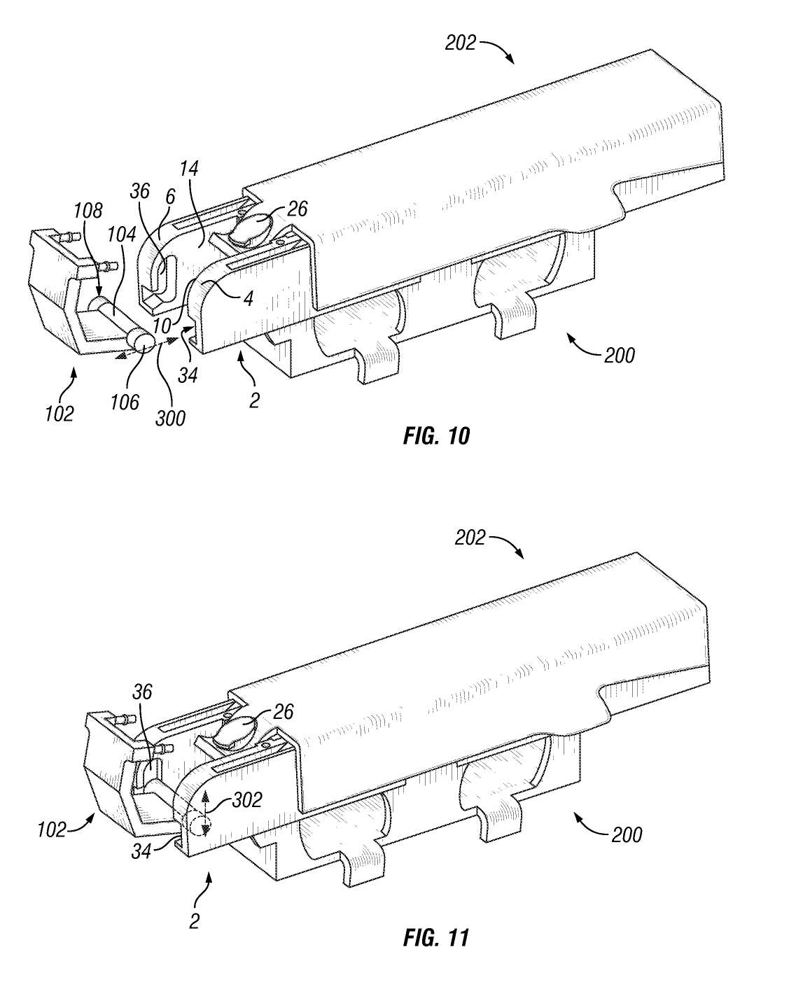

Referring to FIGS. 10-15, the sequential drawings show the releasable engagement of locking tab 102 with the example assembly of wiper blade connector 200, wiper blade adapter 2, and wiper arm 202 after the example assembly has been releasably engaged as shown in FIG. 9. More specifically, the position(s) of locking tab 102 from FIG. 10 through FIG. 15 disclose an example process for releasably engaging locking tab 102 with the example assembly.

FIG. 10 shows locking tab 102 of FIG. 6 positioned to releasably engage the example assembly of FIG. 9. FIG. 10 shows an alignment of ends 106, 108 of base 104 of locking tab 102 with guiding slots 34, 36, respectively, of inner surfaces 10, 14, respectively. Arrow 300 indicates a general direction of movement of locking tab 102.

FIG. 11 shows locking tab 102 of FIG. 6 releasably engaging wiper blade adapter 2 in a first position. Locking tab 102 is shown approximately half-way through guiding slots 34, 36 of wiper blade adapter 2. Locking tab 102 initially engages wiper blade adapter 2 in a generally linear, horizontal motion relative to wiper blade adapter 2 and then the guiding slots 34, 36 provide for a generally vertical motion, in other words, a sliding up of locking tab 102. Arrow 302 indicates a general direction of movement of locking tab 102.

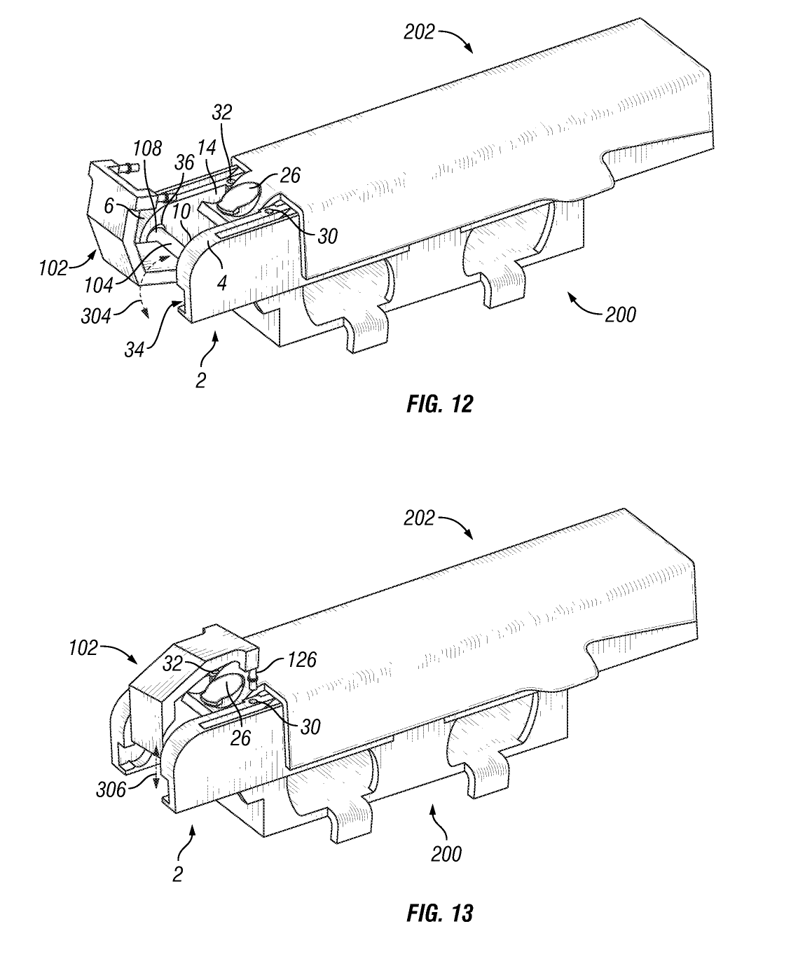

FIG. 12 shows locking tab 102 of FIG. 6 releasably engaging wiper blade adapter 2 in a second position. FIG. 12 shows end 108 of base 104 releasably engaging near the end of second guiding slot 36 of inner surface 14. Similarly, while not shown, end 106 of base 104 is releasably engaging near the end of first guiding slot 34 of inner surface 10. The position of first end 106 and second end 108 within the respective guiding slots provides for locking tab 102 to be rotated towards lock post 26 and lock pin holes 30, 32. Arrow 304 indicates a general direction of movement of locking tab 102.

FIG. 13 shows locking tab 102 of FIG. 6 releasably engaging wiper blade adapter 2, wiper blade connector 200, and wiper arm 202 in a third position. After locking tab 102 has been rotated towards lock post 26, prong 126 and prong 128 (not shown) can be positioned over lock pin holes 30, 32, respectively, to provide for subsequent positioning and locking of locking tab 102. Arrow 306 indicates a general direction of movement of locking tab 102.

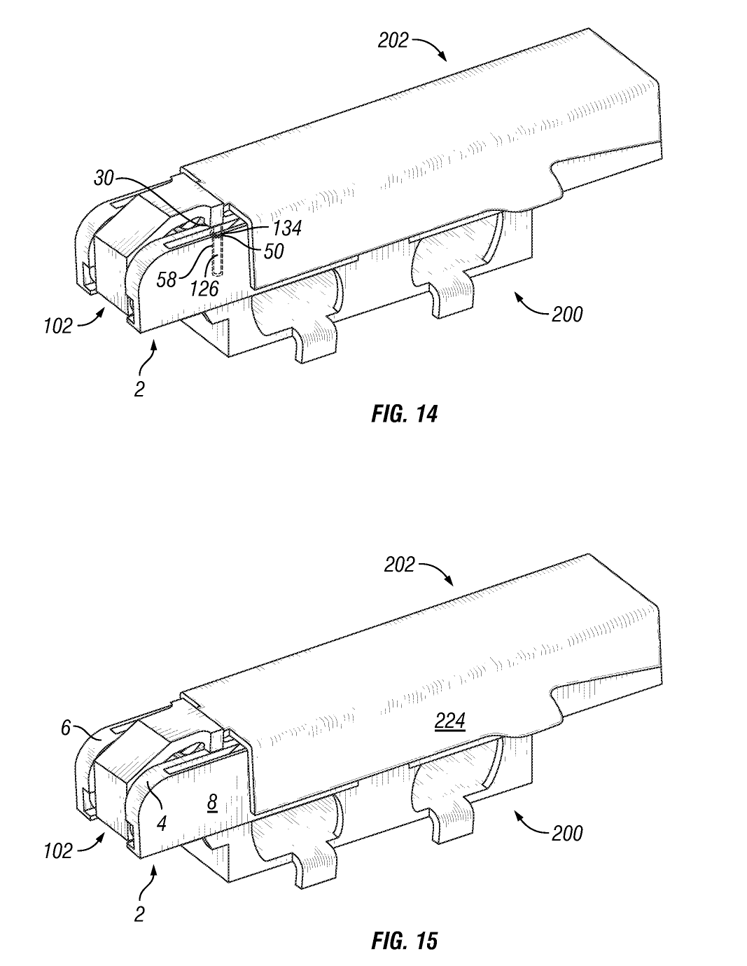

FIG. 14 shows locking tab 102 of FIG. 6 releasably engaging wiper blade adapter 2, wiper blade connector 200, and wiper arm 202 in a fourth position. First prong 126 has been inserted into first passageway 58. Second prong 128 has been inserted into second passageway 64 (not shown). After locking tab 102 has been positioned and moved downward as described with reference to FIG. 13, first ring 134 of first prong 126 can engage with first groove 50 of first lock pin hole 30. Similarly, second ring 140 of second prong 128 can engage with second groove 52 of second lock pin hole 32 (not shown). The engaging of the grooves and rings provides for a groove-ring snap connection.

FIG. 15 shows locking tab 102 of FIG. 6 releasably engaging with wiper blade adapter 2, wiper blade connector 200, and wiper arm 202 in a fifth position.

While the wiper blade adapter and the locking tab have been described herein with reference to lock pin holes, grooves within the lock pin holes, prongs, rings of the prongs, and engaging of the grooves and rings providing for groove-ring snap connections, it should be understood that any type of means for releasably engaging the locking tab with the wiper blade adapter may be utilized as long as such means for releasably engaging provides for at least a portion of a wiper arm to be retained between the wiper blade adapter and the locking tab after releasable engagement. Means for releasably engaging the locking tab with the wiper blade adapter include, for example, groove-ring snap connections, ball-and-socket snap connections, and combinations thereof.

For example, the wall extensions and lock pin holes having grooves may be substituted with socket-type receptacles and the rings of the prongs of the locking tab may be substituted with ball-type projections.

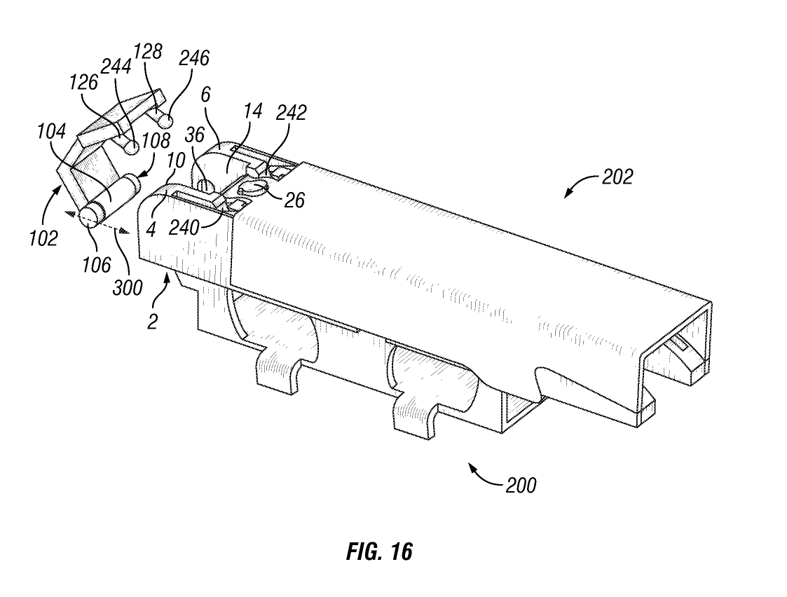

FIG. 16 shows, for example, walls 4,6 of wiper blade adapter 2 each comprising a socket-type receptacle 240, 242, respectively. FIG. 16 also shows, for example, prongs 126, 128 of locking tab 102 each comprising a ball-type projection 244, 246, respectively, thus providing for a ball-and-socket snap connection of the locking tab with the wiper blade adapter.

Also for example, a combination of the groove-ring snap connection and the ball-and-socket snap connection may be utilized.

A wiper blade adapter in accordance with the present invention may be pre-installed on a wiper blade connector that may be pre-installed on a wiper blade or included with a wiper blade in a package for later installment. Also, while the wiper blade adapter and the wiper blade connector have been described herein as separate components, it should be understood that the wiper blade adapter and the wiper blade connector may comprise one integrated unit that may be pre-installed on a wiper blade or included with a wiper blade in a package for later installment.

A wiper blade adapter and a locking tab in accordance with the present invention may be manufactured from any suitable material including, for example, plastic, thermoplastic, and metal.

The foregoing description is intended as a means of illustration and should not be construed as limiting the scope of the invention in any way. Those skilled in the art will recognize many variations that may be made without departing from the spirit of the disclosed invention.

1. An apparatus for connecting a wiper blade to a wiper arm, comprising a wiper blade adapter and a locking tab wherein the locking tab is releasably engageable with the wiper blade adapter such that when the locking tab releasably engages the wiper blade adapter at least a portion of the wiper arm is retained between the wiper blade adapter and the locking tab.

2. The apparatus of claim 1 wherein the wiper blade adapter comprises a first wall and a second wall and further wherein the adapter comprises a connector connecting the first wall and the second wall.

3. The apparatus of claim 2 wherein the wiper blade adapter further comprises a lock post.

4. The apparatus of claim 3 wherein the wiper blade adapter further comprises a lock post support.

5. The apparatus of claim 1 further comprising a means for releasably engaging the locking tab with the wiper blade adapter.

6. The apparatus of claim 5 wherein the means for releasably engaging the locking tab with the wiper blade adapter are selected from the group consisting of groove-ring snap connections, ball-and-socket snap connections, and combinations thereof.

7. The apparatus of claim 2 wherein the wiper blade adapter further comprises a first guiding slot and a second guiding slot.

8. The apparatus of claim 7 wherein the first guiding slot is located at the inner surface of the first wall and further wherein the second guiding slot is located at the inner surface of the second wall.

9. The apparatus of claim 1 wherein the locking tab comprises a base and a first wall extending up from the base.

10. The apparatus of claim 9 wherein the base comprises a first end and a second end.

11. The apparatus of claim 10 wherein a first edge of the first wall of the locking tab is positioned at a distance from the first end of the base wherein the distance is nearly equal to the depth of a first guiding slot located at an inner surface of a first wall of the wiper blade adapter and further wherein a second edge of the first wall of the locking tab is positioned at a distance from the second end of the base wherein the distance is nearly equal to the depth of a second guiding slot located at an inner surface of a second wall of the wiper blade adapter.

12. The apparatus of claim 11 wherein the first wall of the locking tab comprises three sections.

13. The apparatus of claim 1 wherein the wiper arm is an insert-and-lock wiper arm.

14. A process for connecting a wiper blade to a wiper arm, comprising releasably engaging a locking tab with a wiper blade adapter such that when the locking tab releasably engages the wiper blade adapter at least a portion of the wiper arm is retained between the wiper blade adapter and the locking tab.

15. The process of claim 14 further comprising aligning a first end of a base of the locking tab with a first guiding slot located at an inner surface of a first wall of the wiper blade adapter and aligning a second end of the base of the locking tab with a second guiding slot located at an inner surface of a second wall of the wiper blade adapter.

16. The process of claim 15 further comprising inserting the first end of the base of the locking tab into the first guiding slot and inserting the second end of the base of the locking tab into the second guiding slot.

17. The process of claim 16 further comprising rotating the locking tab and releasably engaging a means for releasably engaging the locking tab with the wiper blade adapter.

18. The process of claim 17 wherein the means for releasably engaging the locking tab with the wiper blade adapter are selected from the group consisting of groove-ring snap connections, ball-and-socket snap connections, and combinations thereof.

19. The process of claim 14 wherein the wiper arm is an insert-and-lock wiper arm.

20. The process of claim 14 further comprising releasably engaging the wiper blade adapter with a wiper blade connector.
